(19) United States
(12) Patent Application Publication
(10) Pub. No.: US 2015/0357694 A1
(43) Pub. Date: Dec. 10, 2015

(54) DEVICE FOR TRANSMITTING ENERGY FROM ONE MEDIUM TO ANOTHER

(71) Applicant: THALES, Courbevoie (FR)

(72) Inventors: Philippe Hervé DENIS, CHOISY LE ROI (FR); Jean-François JARNO, SURESNES (FR); Jean-Claude RACAMIER, MEUDON LA FORET (FR)

(21) Appl. No.: 14/731,690

(22) Filed: Jun. 5, 2015

(30) Foreign Application Priority Data
Jun. 6, 2014 (FR) 1401301

(51) Int. Cl. H01P 1/08

(52) U.S. Cl. CPC H01P 1/08

(57) ABSTRACT

A device for transmitting energy comprises: a wall separating two media; and at least one conductive element passing through the wall, the conductive element comprising an energetically conductive material extending in a longitudinal direction. The conductive element is joined to the wall and comprises a hole passing through the wall and extending in a direction substantially parallel to the longitudinal direction on either side of the surfaces of the wall, over respective lengths that are larger than or equal to the largest dimension of a cross section of the conductive element considered level with the wall, the maximum ratio of the area of the cross section of the conductive element with the hole to the area of the cross section of the conductive element without the hole level with the wall being higher than or equal to a threshold comprised between 0.85 and 0.95.

### CROSS-REFERENCE TO RELATED APPLICATION

This application claims priority to foreign French patent application No. FR 1401301, filed on Jun. 6, 2014, the disclosure of which is incorporated by reference in its entirety.

### FIELD OF THE INVENTION

The invention relates to a device allowing energy to be transmitted from one medium to another.

More precisely, the invention relates to a device allowing energy to pass, such as a microwave window, for example, able notably to be used at the exit of a power electron tube to transmit a microwave-frequency electromagnetic wave between the interior of a tube, which is possibly under vacuum, and the exterior of the tube at atmospheric pressure, the tube possibly being an amplifier such as a travelling wave tube.

### BACKGROUND

FIG. 1 is a conventional representation of a microwave window. The microwave window 1 comprises a wall 2 and typically the wall 2 comprises a ceramic material such as alumina.

The microwave window 1 furthermore comprises a core 3 passing through the wall 2, the core 3 extending in a longitudinal direction d_{Long}.

A cladding 4 comprising a material ensuring thermomechanical and microwave matching is arranged coaxially around the wall 2.

A body 5 made of a metal, stainless steel for example, allows a coupled assembly to be created that can be assembled with an electron tube.

All of these parts are assembled by brazing, the core 3 being sufficiently small in size that expansion differences allow a satisfactory mechanical strength to be guaranteed. Typically, the diameter d1 of the core 3 is about 0.5 mm.

This first solution is complex to implement and it requires a plurality of assembly and brazing steps.

Another solution consists in using a core 3 comprising controlled expansion materials.

The low thermal expansion materials generally used are Fénico (registered trademark) having a low thermal elongation coefficient of about 0.0121 mm per mm at 1010° C., or molybdenum having an elongation coefficient of about 0.0057 mm per mm at 1010° C.

One drawback of microwave windows using controlled expansion materials is that these materials are highly resistive, thereby limiting power transmission capability.

Another possible solution consists in using a material such as moly-copper associating the low thermal expansion properties of molybdenum and the good energy conduction properties of copper.

### SUMMARY OF THE INVENTION

One aim of the invention consists in providing an alternative device for transferring energy from one medium to another whether hermetically or not.

According to one aspect of the invention, a device for transmitting energy is provided, comprising:
a wall separating two media; and
at least one conductive element passing through the wall, the conductive element comprising an energetically conductive material extending in a longitudinal direction,
   the conductive element being joined to the wall and furthermore comprising a hole passing through the wall and extending in a direction substantially parallel to the longitudinal direction on either side of the surfaces of the wall over respective lengths that are larger than or equal to the largest dimension of a cross section of the conductive element, the cross section of the conductive element being considered level with the wall, and the ratio of the area of the cross section of the conductive element with the hole to the area of the cross section of the conductive element without the hole, the cross sections St and Sc being considered level with the wall, being higher than or equal to a threshold comprised between 0.85 and 0.95. Advantageously, the threshold is higher than 0.9.

The invention allows highly energetically conductive materials such as copper, gold or silver to be assembled with thin dielectrics or thermal insulators such as alumina for example.

This embodiment obtains a good compromise between the capacity of the conductive element to relieve mechanical stresses and a high level of power transfer.

Advantageously, the cross section Sc of the conductive element in the thickness of the wall is circular and constant, thereby facilitating implementation. The cross section Sc of the conductive element has a first diameter smaller than or equal to 3 mm.

When the invention is applied to microwave tube coaxial exit windows with such a dimension smaller than or equal to 3 mm (by way of example of such tubes, mention may be made of TWTs) output powers may be obtained in the 100-300 W range because power transmission through the window remains high (relative to this small cross section of 3 mm diameter) because the hollowed out portion of the window has a small cross section (10% of the cross section of a “solid” window).

Advantageously, the cross section of the hole is circular and constant.

Advantageously, the thickness of the wall in the longitudinal direction is smaller than or equal to 1 mm depending on the flexibility required to accommodate for the various thermomechanical stresses created during the various assembly phases and during stresses due to the transfer of electrical or microwave energy.

Advantageously, the device for transmitting energy such as described above is a microwave window.

According to another aspect of the invention, a device such as described above is provided comprising a plurality of conductive elements arranged substantially parallel to the longitudinal direction, the distance between two successive conductive elements being larger than or equal to 0.5 mm.

### BRIEF DESCRIPTION OF THE DRAWINGS

The invention will be better understood and other advantages will become apparent on reading the following nonlimiting description, and by virtue of the appended figures, in which:

FIG. 1, described above, shows a first microwave window according to the prior art;

FIG. 2 shows a device for transmitting energy from one medium to another, according to one aspect of the invention; and

FIG. 3 shows a multiple passage device for passing energy from one medium to another, according to another aspect of the invention.

### DETAILED DESCRIPTION

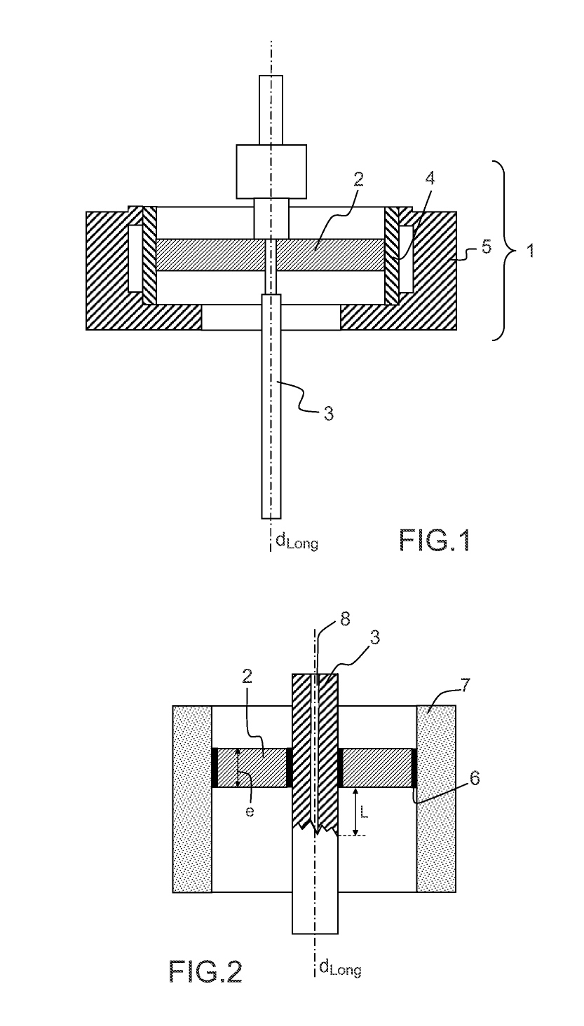

One embodiment of the invention is shown in FIG. 2.

In the case in point, the device comprises a wall 2 comprising an electrically and thermally insulating material such as a ceramic, alumina being very particularly suitable. The wall 2 is joined to connector parts 7, for example using brazed joints 6.

The transmitting device according to one aspect of the invention allows a conductive element 3 to be assembled with a thermally and/or electrically insulating wall 2.

The wall 2 may be of any thickness e; however, the device described is particularly applicable to devices notably having a small wall 2 thickness e, typically smaller than about 1 mm.

This is because mechanical stresses due to temperature variations are, for this type of device, correspondingly more critical to the integrity of the energy transmitting device.

The conductive element 3 extends in a longitudinal direction d_{Long} and passes through the wall 2.

The conductive element 3 comprises a material having good energy conduction properties, such as copper. The transmitted energy will possibly take the form of thermal energy, an electrical current or electromagnetic waves.

The cross section Sc of the conductive element 3 considered level with the wall 2 may be of any size; the cross section Sc of the conductive element 3 is preferably circular and constant in the thickness e of the wall 2 and has a first diameter d1.

The conductive element 3 is joined to the wall 2, optionally hermetically depending on the applications for which the energy transmitting device is intended. The join may for example be achieved by means of an adhesive, brazed joints or welded joints. In the case in point, the join is achieved using brazed joints 6.

The conductive element 3 furthermore comprises a hole 8 extending in a direction substantially parallel to the longitudinal direction d_{Long} and protruding on either side of the surfaces of the wall 2 over lengths L that are larger than or equal to the largest dimension of the cross section Sc of the conductive element 3, the cross section Sc of the conductive element 3 being considered level with the wall 2.

In other words, if the cross section Sc of the conductive element 3 is circular and constant in the thickness e of the wall 2, the hole 8 extends on either side of the surfaces of the wall 2 or, in other words, protrudes on either side of the surfaces of the wall 2, over respective lengths that are larger than or equal to the first diameter d1 thus limiting expansionary and compressive mechanical stresses generated by temperature variations during the passage of the energy.

The hole 8 may be located in any position, but advantageously the hole 8 is centred. The hole 8 may be blind or open onto one or other of the ends. Preferably, the hole 8 opens onto at least one of the ends of the conductive element 3. The hole 8 may have any cross section St; preferably the cross section St of the hole 8 is circular and constant in the thickness e of the wall 2, thereby allowing the hole 8 to be formed by drilling. The hole 8 has a second diameter d2.

Advantageously, the ratio of the area of the cross section Sc of the conductive element 3 after the hole 8 has been drilled to the area of the cross section Sc of the conductive element 3 before the hole 8 has been drilled is comprised between 0.85 and 0.95, and is preferably higher than or equal to 0.9.

In other words, the cross section Sc of the conductive element 3 after drilling is larger than 90% of the cross section Sc of the conductive element 3 before drilling. Thus, the loss of effective area allowing energy to be transferred is very small.

Therefore, if the cross section Sc of the conductive element 3 and the cross section St of the hole 8 are circular in the thickness of the wall 2, the ratio of the second diameter d2 of the hole 8 to the first diameter dl of the conductive element 3 is then 0.3 at least. The diameter of the drill hole may be the smallest producible, typically 0.2 mm.

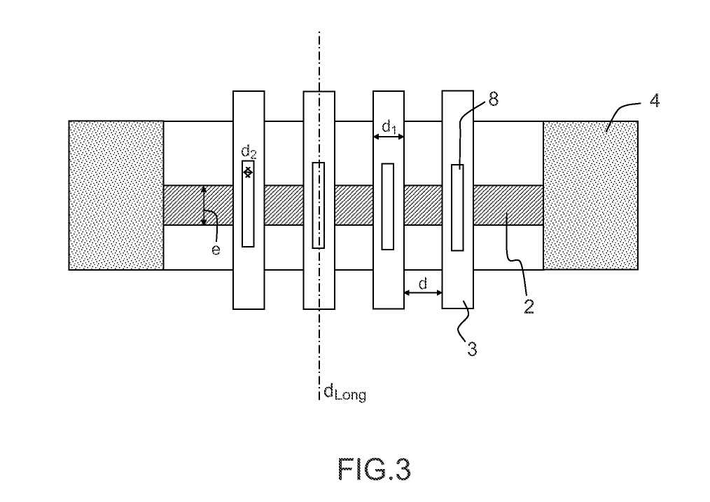

Another aspect of the invention consists in placing a plurality of high-power energy transmission enabling microwave devices substantially parallel to the longitudinal direction d_{Long}. This aspect of the invention is shown in FIG. 3.

Advantageously, the distance between two successive devices for transmitting energy is larger than or equal to 0.5 mm.

1. A device for transmitting energy, comprising:
a wall separating two media; and
at least one conductive element passing through the wall, the conductive element comprising an energetically conductive material extending in a longitudinal direction;
wherein the conductive element is joined to the wall and comprises a hole passing through the wall and extending in a direction substantially parallel to the longitudinal direction on either side of the surfaces of the wall, over respective lengths that are larger than or equal to the largest dimension of a cross section of the conductive element considered level with the wall, the maximum ratio of the area of the cross section of the conductive element with the hole to the area of the cross section of the conductive element without the hole level with the wall being higher than or equal to a threshold comprised between 0.85 and 0.95.

2. The device for transmitting energy according to claim 1, in which the threshold is higher than 0.9.

3. The device for transmitting energy according to claim 1, in which the cross section of the conductive element in the thickness of the wall is circular, constant and has a first diameter.

4. The device for transmitting energy according to claim 3, in which the first diameter is smaller than or equal to 3 mm.

5. The device for transmitting energy according to claim 1, in which a cross section of the hole considered level with the wall is circular and constant.

6. The device for transmitting energy according to claim 1, in which the thickness of the wall in the longitudinal direction is smaller than or equal to 1 mm.

7. The device for transmitting energy according to claim 1, comprising a plurality of conductive elements arranged substantially parallel to the longitudinal direction, the distance between two successive conductive elements being larger than or equal to 0.5 mm.

8. The device for transmitting energy according to claim 1, being a microwave window.
